(19) United States
(12) Patent Application Publication
(10) Pub. No.: US 2010/0071215 A1
(43) Pub. Date: Mar. 25, 2010

(54) TRIMMER FOR SHAVING RAZOR

(76) Inventor: Jeffrey W. Wonderley, Fort Defiance, VA (US)

Correspondence Address: MCDERMOTT WILL & EMERY LLP, 600 13TH STREET, N.W., WASHINGTON, DC, 20005-3096, US

(21) Appl. No.: 12/567,390

(22) Filed: Sep. 25, 2009

Related U.S. Application Data
(60) Provisional application No. 61/099,969, filed on Sep. 25, 2008.

(51) Int. Cl. B26B 21/40; B26B 21/14

(52) U.S. Cl. 30/34.1; 30/77

(57) ABSTRACT

A trimmer for a shaving razor comprises a blade having a cutting edge. A plurality of teeth are located on one side of said blade at the cutting edge. On a second side of the blade opposite the plurality of teeth are a plurality of ribs located at the cutting edge. Each of the teeth are aligned with the ribs in a direction perpendicular to the blade. Alternatively, the teeth and ribs are spaced alternating along the cutting edge of the blade. The number of teeth are equal to or alternatively, not equal to the number of ribs.

### CROSS REFERENCE TO PROVISIONAL APPLICATION

This application is based upon and claims the benefit of priority from Provisional U.S. Patent Application 61/099,969 (Attorney docket No. 044210-0413) filed on Sep. 25, 2008, the entire contents of which are incorporated by reference herein.

### TECHNICAL FIELD

The present disclosure relates to a trimmer for a shaving razor. More particularly, the present disclosure has applicability to a trimmer for multi-blade shaving razors.

### BACKGROUND

Heretofore, devices commonly used for removing facial hair have consisted of the “old fashioned” straight razor, the safety razor and the electric dry shaver. The safety razor, the most popular shaving implement, is especially adapted for the “clean shaven” look wherein facial hair is entirely removed. The principle of the safety razor is to place a guard between the skin and the cutting edge of a razor blade, so that the guard permits the cutting edge to pass over the surface to be shaved, removing the hair without cutting the skin. The safety razor is not satisfactory for grooming and shaping beards, moustaches and sideburns because the blade holder and guard obscure the cutting edge from the user's view and the configurations of the holder, guard and blade are not adapted for the shaping and trimming of the margins of beards, moustaches and sideburns. In addition, the guard makes it difficult to reach certain portions of the beard that are desired to be cut.

### SUMMARY OF THE DISCLOSURE

In order to overcome the above mentioned problems, the present disclosure provides a novel trimmer for a shaving razor. The trimmer comprises a blade having a cutting edge. In one embodiment, a plurality of teeth are located on one side of said blade at the cutting edge. On the side of the blade opposite the plurality of teeth are a plurality of ribs located at the cutting edge. In certain embodiments, each of the teeth are aligned with the ribs in a direction perpendicular to the longitudinal axis of the blade. Alternatively, the teeth and ribs are spaced alternating along the cutting edge of the blade. The number of teeth are equal to and alternatively, not equal to the number of ribs. Alternatively, the teeth are set on a platform.

In another embodiment, the blade has through holes, through which the ribs extend and interlock with the teeth. An outer edge of the ribs has a point with a tangent line parallel to the cutting plane of the trimmer that is aligned with the cutting plane of the trimmer. Alternatively, the tangent line is aligned behind or in ahead of the cutting plane of the trimmer.

The configuration of elements in the trimmers of the present disclosure provide safety against nicks and cuts without the necessity of a guard along the entire length of the blade. This prevents cut whiskers or hair from getting caught between the blade and other guard surfaces. The teeth and the ribs both reduce drag from surface friction by reducing the area of contact with skin at the point of use, thereby increasing comfort. Further, the varied spacing and alignment of the teeth and ribs allows for different degrees of comfort and protection.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a front view of a trimmer of one embodiment of the present disclosure with ribs and teeth aligned.

FIG. 2 is a front view of a trimmer of another embodiment of the present disclosure with ribs spaced alternately from teeth.

FIG. 3 is a front view of a trimmer of another embodiment of the present disclosure showing the interlocking portion of the ribs.

FIG. 4 is a cutaway side view of a trimmer of an embodiment of the present disclosure with a rib at the cutting plane of the trimmer.

FIG. 5 is a cutaway side view of a trimmer of an embodiment of the present disclosure with a rib above the cutting plane of the trimmer.

FIG. 6 is a cutaway side view of a trimmer of an embodiment of the present disclosure with a rib behind the cutting plane of the trimmer.

FIG. 7 is a cutaway side view of a trimmer of an embodiment of the present disclosure with a rib having a continuous profile with the teeth of the platform.

FIGS. 8a-d is a view of a shaving razor cartridge having a trimmer of one embodiment of the present disclosure.

### DETAILED DESCRIPTION OF THE DISCLOSURE

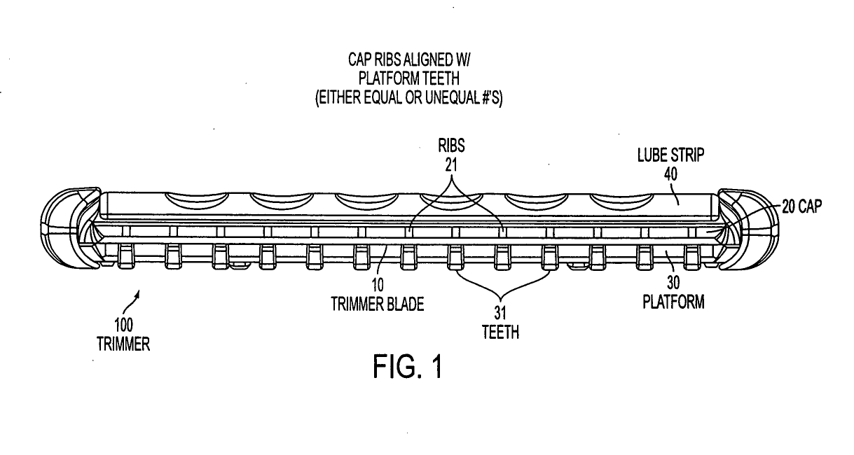

FIG. 1 is a front view of a trimmer 100 of one embodiment of the present disclosure. The trimmer comprises a trimmer blade 10, having a cap 20 on one side of the blade 10 and a platform 30 on other side of the blade, opposite the cap 20. The cap 20 has a series of ribs 21, spaced along the cap at the cutting edge of the blade 11. A lube strip 40 is positioned to the rear of the cap 20. The platform 30 has a series of teeth 31 also spaced along the cap. In this embodiment, the teeth 31 are in alignment with the ribs 21 in a direction perpendicular to the longitudinal axis of the trimmer blade 10.

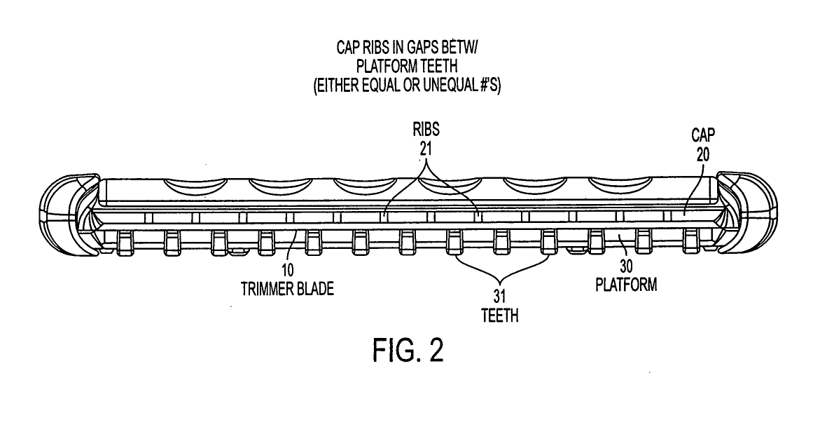

FIG. 2 shows another embodiment of the trimmer. In this embodiment, the ribs 21 and teeth 31 are alternately spaced along the cutting edge of the trimmer blade 11.

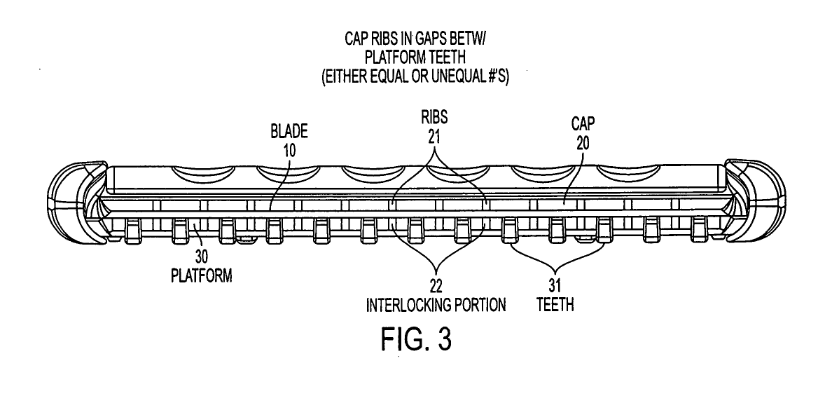

FIG. 3 shows an embodiment in which the ribs 21 extend through the blade 10 and interlock with the platform 30 via an interlocking portion 22. Alternatively, the interlocking portion 22 can interlock with the teeth 31 directly.

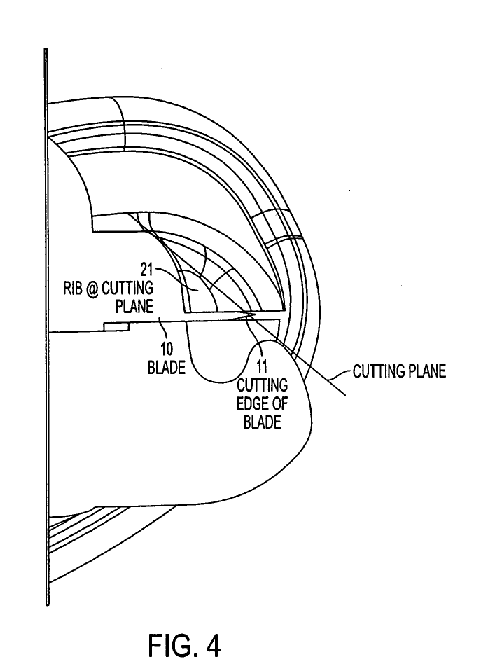

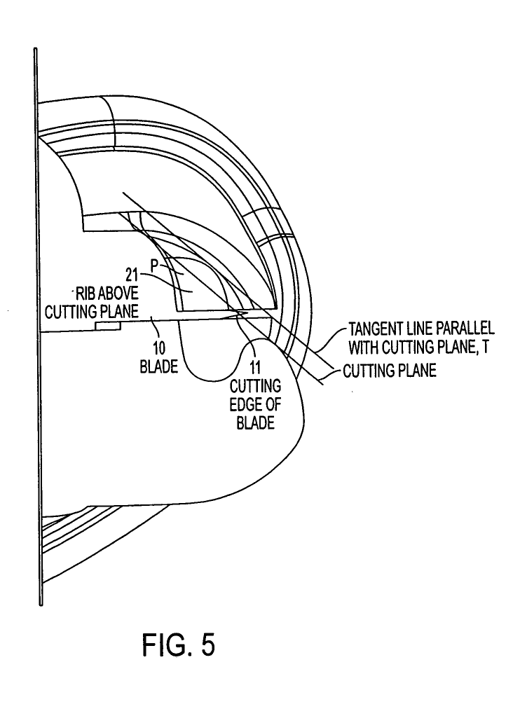

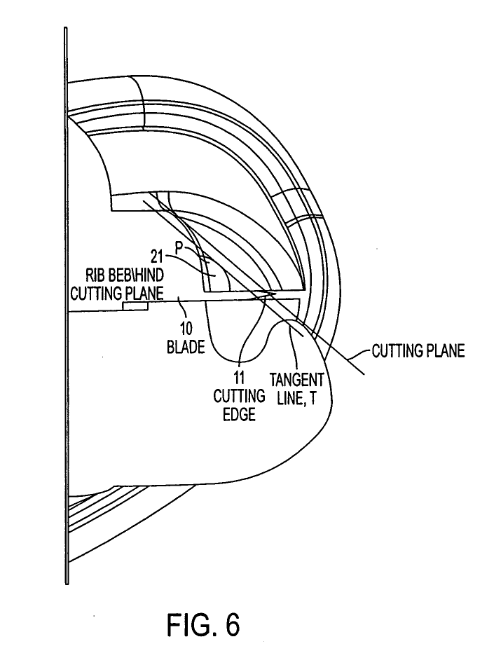

The number of ribs 21 on the cap 20 may vary. In some embodiments, as shown in FIGS. 1-3, there are a plurality of ribs 21. For example, there are 13 ribs in FIGS. 1 and 12 in FIG. 2. In other embodiments, as may be envisioned in FIG. 4, the cap has one single rib, which runs along at least a portion of the upper surface of the blade 10. Alternatively, the cap has a bar or guard located on one side of said blade at the cutting edge. FIG. 4 also shows the alignment of the rib 21 in relationship to the cutting plane of the trimmer 100. As is shown, a point on the rib 21 has a tangent that is parallel to and abuts, or overlaps, the cutting plane of the trimmer 100. In other embodiments, the parallel tangent is positioned ahead the cutting plane (FIG. 5), or the parallel tangent is positioned behind the cutting plane (FIG. 6). In the present disclosure, the term “cutting plane” is defined as the plane tangent to skin engaging surfaces of the trimmer, which respectively engages the skin before and after engagement of the skin by the blade. Other terms that may be interchangeably used for cutting plane are, for example, “shaving plane” or “trimming plane”.

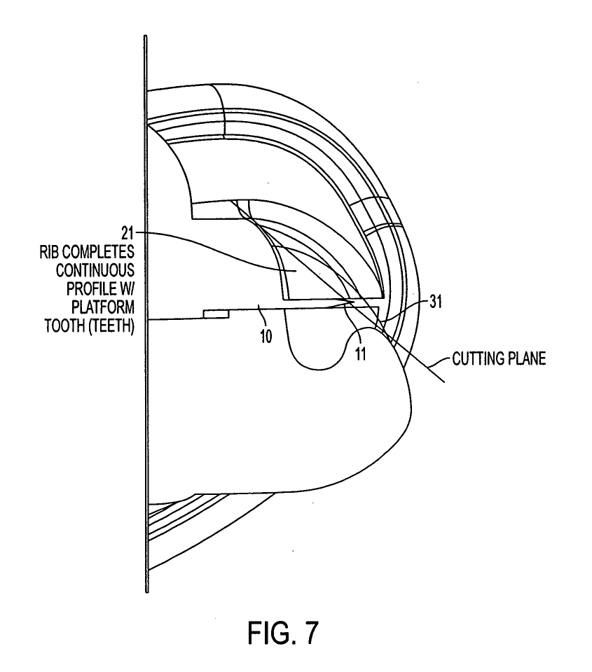

FIG. 7 shows another embodiment of the present disclosure in which the rib 21 has a side profile such that the rib 21 completes a continuous profile with the teeth 31 of the platform 30. As can be seen, a continuous curved line is drawn along the outside edge of the rib 21 and teeth 31, showing a continuous profile only interrupted by the gap provided for the cutting edge of the blade 11.

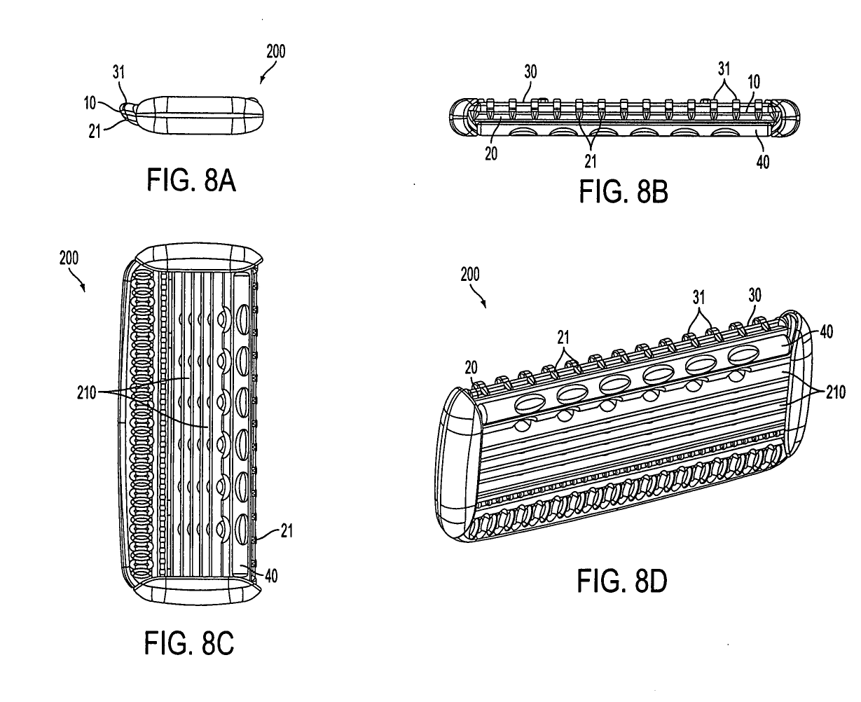

The trimmer 100 of the present disclosure is adaptable to any shaving razor cartridge. For example, FIGS. 8a-d show a razor cartridge 200 having razor blades 210 having cutting edges that face in the opposite direction of the cutting edge of the trimmer blade 11. In some embodiments, the trimmer blade and the razor blades are planar or alternatively, the trimmer blade and razor blades have a curved shape.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A trimmer for a shaving razor comprising:
a blade having a cutting edge;
a plurality of teeth located on one side of said blade at the cutting edge; and
a plurality of ribs located on a second side of the blade opposite the plurality of teeth at the cutting edge.

2. The trimmer of claim 1, wherein said plurality of teeth are in alignment with the plurality of ribs in a direction perpendicular to a longitudinal axis of the blade.

3. The trimmer of claim 1, wherein said plurality of teeth are spaced alternately with the plurality of ribs in a direction perpendicular to a longitudinal axis of the blade.

4. The trimmer of claim 1, wherein the number of teeth is equal to the number of ribs.

5. The trimmer of claim 1, wherein the number of teeth is not equal to the number of ribs.

6. The trimmer of claim 1, wherein the blade has a plurality of through holes aligned with the ribs and teeth, and
the ribs extend through the through holes to interlock with the teeth.

7. The trimmer of claim 1, wherein a rib has a curved outer edge;
and a tangent of a point on the outer edge of the rib parallel with a cutting plane of the trimmer, is in said cutting plane.

8. The trimmer of claim 1, wherein a rib has a curved outer edge;
and a tangent of a point on the outer edge of the rib parallel with a cutting plane of the trimmer, is behind said cutting plane.

9. The trimmer of claim 1, wherein a rib has a curved outer edge;
and a tangent of a point on the outer edge of the rib parallel with a cutting plane of the trimmer, is ahead said cutting plane.

10. The trimmer of claim 1, further comprising a platform, wherein the plurality of teeth are disposed on the platform.

11. The trimmer of claim 10, wherein the blade has a plurality of through holes aligned with the ribs, and
the ribs extend through the through holes to interlock with the platform.

12. A trimmer for a shaving razor comprising:
a blade having a cutting edge;
a plurality of teeth located on one side of said blade at the cutting edge; and
a rib located on a second side of the blade opposite the plurality of teeth at the cutting edge.

13. A trimmer for a shaving razor comprising:
a blade having a cutting edge;
a guard located on one side of said blade at the cutting edge; and
a plurality of ribs located on a second side of the blade opposite the guard at the cutting edge.

14. A shaving razor cartridge comprising:
the trimmer of claim 1; and
a razor blade having a cutting edge,
wherein the cutting edge faces a direction opposite the cutting edge of the trimmer blade.

15. The trimmer of claim 1, wherein the trimmer blade has a planar shape.
